(19) United States
(12) Patent Application Publication
(10) Pub. No.: US 2015/0051035 A1
(43) Pub. Date: Feb. 19, 2015

(54) NON-MARKING ROLLER CHAIN

(71) Applicant: John Richard Wilbur, Bettendorf, IA (US)

(72) Inventor: John Richard Wilbur, Bettendorf, IA (US)

(21) Appl. No.: 14/459,665

(22) Filed: Aug. 14, 2014

Related U.S. Application Data
(60) Provisional application No. 61/865,930, filed on Aug. 14, 2013.

(51) Int. Cl. F16G 13/06

(52) U.S. Cl. CPC F16G 13/06
USPC 474/231

(57) ABSTRACT

A roller chain may include a series of roller links and pin links Each pin link may include composite pin link plates, each having a metallic plate component and a plastic plate component. The metallic plate component may be fixedly mounted on a pair of spaced metallic pin members, and the plastic plate component may be fixedly connected to the metallic plate component and have a pocket formed therein that complementarily receives the metallic plate component.

### RELATED APPLICATIONS

The present utility patent application claims priority from and the benefit of U.S. Provisional Patent Application No. 61/865,930, filed Aug. 14, 2013, entitled NON-MARKING ROLLER CHAIN, the contents of which is hereby incorporated by reference in its entirety.

### FIELD OF THE DISCLOSURE

The present disclosure is related to a pin link of a roller chain, a method of manufacturing a pin link and roller link combination and a chain including the pin link and roller link, and more particularly, to a multi-component pin link of a roller chain, a method of manufacturing the pin link and roller link combination and a chain including the pin link and roller link.

### BACKGROUND

A roller chain is a type of chain drive designed for the transfer of mechanical power in many kinds of domestic, industrial and agricultural machinery, including conveyors, wire and tube drawing machines, printing presses, cars, motorcycles, and simple machines such as bicycles. The chain is commonly driven by a toothed wheel called a sprocket. Commonly, a roller chain has a series of links designed to mesh with the teeth of the sprockets of the machine. The Links are flexible in only one dimension. Each link may include short cylindrical rollers held together by side links with an axle that is connected to the side links and passes through the rollers. It is a simple, reliable and efficient means of power transmission.

Generally, there are two types of links sequentially alternating in a roller chain assembly. The first type is an inner or roller link that has two parallel inner plates held together by two axles or bushings that are press or interference fit to the inner plates, upon and about which two rollers may rotate. The inner or roller links are interconnected and alternate with the second type, the outer or pin links, which consist of two outer plates held together by pins, and press or interference fit to the outer plates, that pass through the bushings of the inner links. The roller chain design reduces friction compared to simpler designs, resulting in higher efficiency and less wear. The original power transmission chain varieties lacked rollers and bushings, with both the inner and outer plates held by pins which directly contacted the sprocket teeth; however, this configuration exhibited extremely rapid wear of both the sprocket teeth and the plates where they pivoted on the pins. This problem was partially solved by the development of bushed chains, with the pins holding the outer plates passing through bushings or sleeves connecting the inner plates. This distributed the wear over a greater area; however, the teeth of the sprockets still wore more rapidly than is desirable due to the sliding friction against the bushings. The addition of rollers surrounding the bushing sleeves of the chain provided rolling contact with the teeth of the sprockets, resulting in excellent resistance to wear for both the sprockets and the chain. Additionally, there is very low friction between the sprocket and chain, as long as the chain is sufficiently lubricated. Continuous, clean lubrication of roller chains is of primary importance for efficient operation as well as correct tensioning. Carbon steel is a standard material of construction, but where corrosion protection or corrosion resistance are required, there are options of nickel plating, N.E.P. (carbon steel chain with a special multi-layer protective coating), stainless steel and engineering plastic combinations.

Attachments to the roller chain offer a whole range of possibilities for a chain designer or user. Virtually any chain can include attachment links, which allow users to fasten screws to the chain or accurately position products. The possibilities are limited only by the imagination of the designer or user. While there are numerous standard attachments available to fit roller chain, more specialized, function-related attachments are often needed in order to provide conveying solutions for OEM manufacturers or final consumers.

Common attachments may include an integrally formed or multi-piece constructed riser that provides a load-bearing surface disposed above or offset from the roller chain so that the product or material to be conveyed does not contact the roller chain. For example, a roller chain fitted with a plurality of riser attachments may be used in a sawmill to convey sawn lumber along the various steps necessary to produce finished boards. If the lumber was contacted by the roller chain, the lumber would be damaged and finished boards could not be produced. As a result, scrap and costs to the mill operator would increase. However, the roller chain fitted with riser attachments can overcome the disadvantage of a regular roller chain without the riser attachments because the riser attachments form a raised surface offset from the chain that protects the lumber and boards from the chain. A non-marking material may be connected to the upper surface of the riser attachment to further reduce potential damage to the lumber or boards.

One disadvantage of the riser attachment to the conventional roller chain is that the riser attachments are most commonly welded to the chain links, which increases the cost, time and labor involved with making and installing the chain. Additionally, lumber and boards are most commonly loaded onto a conveyor from a lateral direction and, as a result, generate a sizeable amount of lateral load on the attachments. Consequently, the riser attachments commonly break and have to be re-welded. After a few of the riser attachments break, the conveyor line needs to be shut down to repair or replace the attachments or the chain because the lumber or boards will start to contact the roller chain. Both scenarios are costly and time consuming to the mill operator.

Another attempt to provide a non-marking chain includes roller links and pin links, where the pin links include a metal plate and a plastic plate. The metal and plastic plates are disposed in a parallel, side-by-side relationship, where the plastic plate is larger than the metal plate and extends above the parallel sides of the metal plate, so as to provide a non-marking surface for the conveyed product. A disadvantage of this configuration is that the lateral, side loads imparted to the chain links as a result of the product, lumber or boards being moved from one conveyor to the next cause the plastic plate to tilt in the direction of the applied force. As a result of the side-by-side plates, both the metal and the plastic plates are rotated and loosen their connection with the pin. Further, over time, the metal and plastic plates may become separated from one another, potentially increasing the amount of wear. Consequently, continued application of the lateral, side loads further loosens the connection between the metal and plastic plates and the pin until there is a failure of or damage to the product, lumber or boards. Unfortunately, the parallel-plate configuration does not last long in the conveyor environment, and the only way to repair the damaged chain is to replace it with a new chain, which is very costly and time consuming, and then to disassemble the old chain and replace or discard the worn parts, which is very costly. Additionally, the parallel-plate configuration may significantly increase the width of the chain, thereby requiring customized sprockets and other machinery so as to accommodate the greater size of the chain.

Therefore, there is a need in the art for a non-marking roller chain that overcomes the aforementioned disadvantages and provides lower costs.

### BRIEF DESCRIPTION OF THE DRAWINGS

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or functionally equivalent elements. The elements listed in the abstract are not referenced but nevertheless refer by association to the elements of the detailed description and associated disclosure.

FIG. 1 is a perspective view of a section of a roller chain assembly in accordance with one embodiment of the present disclosure where end pin links are dashed and broken to illustrate a continuous series in each longitudinal direction.

FIG. 2 is an exploded view of a portion of the roller chain assembly of FIG. 1 in accordance with one embodiment of the present disclosure.

FIG. 3 is a top plan view of the roller chain assembly of FIG. 1, with a portion partially cross-sectioned to illustrate alignment of parts.

FIG. 4 is an side elevation view of the roller chain assembly of FIG. 1.

### DETAILED DESCRIPTION

The present disclosure is not limited to the particular details of the apparatus depicted, and other modifications and applications may be contemplated. Further changes may be made in the apparatus, device or methods without departing from the true spirit of the scope of the disclosure herein involved. It is intended, therefore, that the subject matter in this disclosure should be interpreted as illustrative, not in a limiting sense.

In one aspect of the present disclosure, a roller chain assembly may include a series of roller links and pin links Each pin link may include a pair of composite pin link plates. Each composite pin link plate may include a metallic plate component and a plastic plate component. The metallic plate component may be fixedly mounted on a pair of spaced metallic pin members and include a pair of apertures for receiving the spaced pin members. The plastic plate component may be fixedly connected to the metallic plate component and include a pocket formed therein that is configured to complementarily receive the metallic plate component and includes a pair of apertures for receiving the spaced pin members. Each roller link may include a pair of roller link plates fixedly mounted on a pair of bushings disposed to turn on the spaced pin members of the pin links and a pair of apertures for receiving the bushings. Preferably, each of the roller links and pin links is adapted to receive a sprocket tooth to facilitate power transmission.

In another aspect of the present disclosure, a metallic plate width may be defined between opposing metallic plate components that is no greater than a plastic plate width defined between opposing plastic plate components.

In yet another aspect of the present disclosure, a gap may be defined between adjacent pairs of plastic plate components such that no more than 5% of a longitudinal length of the roller link plates is uncovered by the adjacent pairs of plastic plate components.

In still another aspect of the present disclosure, each plastic plate component is partially disposed between the pin link plate and the roller link plate.

In still another aspect of the present disclosure, the metallic plate component may include opposing parallel sides that are fixedly connected by friction fit with complementary side walls of the pocket.

In a further aspect of the present disclosure, a roller chain assembly for direct replacement of an existing chain assembly that has an existing width may include a series of roller links and pin links Preferably, a pin link width is no greater than the existing width.

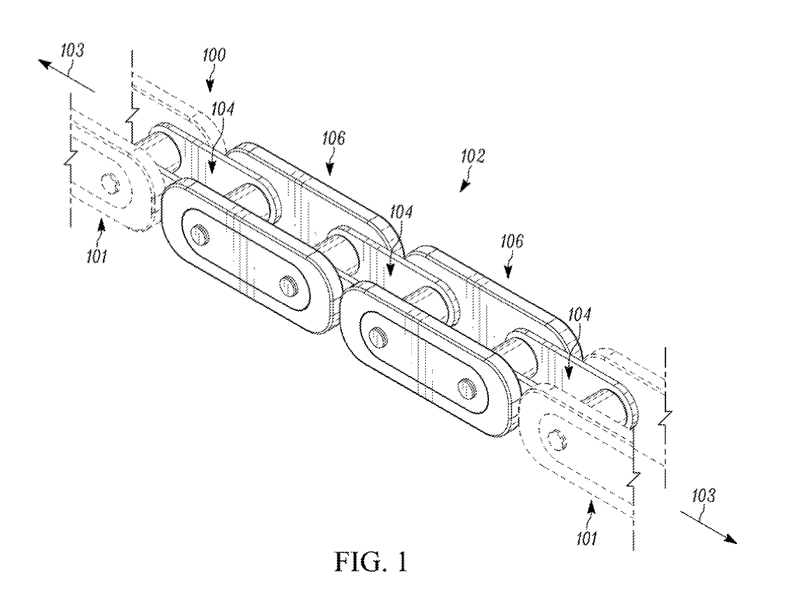

FIG. 1 is a perspective view of a section 102 of a roller chain assembly 100 in accordance with one embodiment of the present disclosure where end pin links 101 are dashed and broken to illustrate a continuous series in each longitudinal direction 103. In one embodiment, the roller chain assembly 100 may include a series of alternately interconnected roller links 104 and pin links 106.

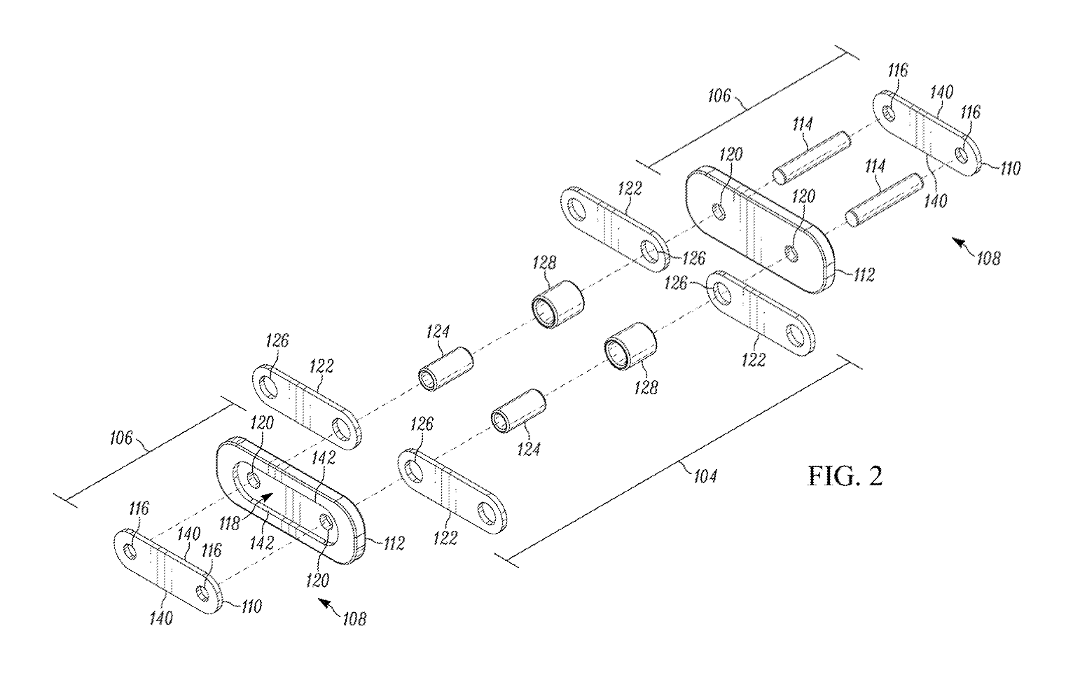

FIG. 2 is an exploded view of a portion of the roller chain assembly 100 of FIG. 1 in accordance with one embodiment of the present disclosure. The pin link 106 may include a pair of composite pin link plates 108. Preferably, each composite pin link plate 108 may include a metallic plate component 110 and a plastic plate component 112. The metallic plate component 110 may be fixedly mounted on a pair of spaced metallic pin members 114 and include a pair of apertures 116 for receiving the spaced pin members 114. The plastic plate component 112 may be fixedly connected to the metallic plate component 110 and include a pocket 118 that is configured to complementarily receive the metallic plate component 110 and includes a pair of apertures 120 for receiving the spaced pin members 114. The metallic plate component 110 and/or plastic plate component 112 may be fixedly connected to the spaced pin members 114 by a press fit, interference fit, friction fit, etc., or the like.

The metallic plate component may be constructed of any suitable material, such as, for example only, steel, aluminum, stainless steel, etc., or the like. The plastic plate component may be constructed of any suitable material, such as, for example only, nylon, nylon 66, glass-reinforced nylon, polyoxymethylene (also known as acetal, polyacetal and polyformaldehyde), similar thermoplastics, etc., or the like. Commonly, the metallic plate component 110 will have a circumferential profile defined by a pair of parallel sides and rounded ends. Likewise, the pocket 118 will have an internal wall circumferential profile defined by a pair of parallel sides and rounded ends. In one embodiment, the pocket 118 may be molded into the plastic plate component. Other methods may be used to achieve the desired functionality, such as, for example only, milling, stamping, etc., or the like. Additionally, the pocket 118 and the metallic plate component 110 may be fixedly connected by a press fit, interference fit, friction fit, etc., or the like. The fixed connection may also be only with respect to selected sections of the metallic plate component 110 and pocket 118 interfaces as desired to facilitate the desired functionality and provide increased life over the existing conventional products. By fixedly connecting the metallic plate component 110 and the pocket 118 together, the metallic plate component 110 and the plastic plate component 112 are much less likely to separate due to lateral force being applied to the plastic plate component 112 during use. Further, both the metallic plate component 110 and the plastic plate component 112 are more likely to remain firmly secured to the spaced pin members, even under lateral stress and after prolonged use. In an embodiment, the circumferential profile of the metallic plate component 110 is completely surrounded by the pocket 118, thereby preventing the metallic plate component 110 from coming into contact with a product, such as lumber or wood, that is carried by the roller chain assembly 100. Similarly, in an embodiment, the interior face of the metallic plate component 110 is entirely covered by the exterior face of the pocket 118, such that the metallic plate component 110 is entirely separated from and prevented from coming into contact with the interconnected roller link 104. This may reduce the friction between each pin link 106 and each roller link 104, as the material used for the plastic plate component 112 may have a significantly lower coefficient of friction than that of the metallic plate component 110. Accordingly, each pin link 106 may rotate easily with respect to each interconnected roller link 104. The friction between each pin link 106 and each roller link 104 may be adjusted as desired to facilitate the desired functionality and provide increased life over the existing conventional products.

Each roller link 104 may include a pair of roller link plates 122 fixedly mounted on a pair of bushings 124 disposed to turn on the spaced pin members 114 of the pin links 106. Each roller link plate 122 may also include a pair of apertures 126 for receiving the bushings 124. A pair of rollers 128 may be disposed to turn on the bushings 124. Each of the roller links 104 and the pin links 106 is adapted to receive a sprocket tooth (not shown) to facilitate power transmission. Accordingly, this roller chain/power transmission environment as disclosed herein is markedly different from a load-bearing chain environment in which the plates may be stacked back to back without any spacing for receipt of a sprocket tooth, which may result in a more stable link design, without any consideration for continuous movement of the endless chain. In one embodiment, the metallic plate component 110 includes opposing parallel sides 140 that may be fixedly connected by friction fit with complementary side walls 142 of the pocket 118. Preferably, the metallic plate component 110 may be a standard-sized side plate used in an all-metal roller chain, which reduces part inventory.

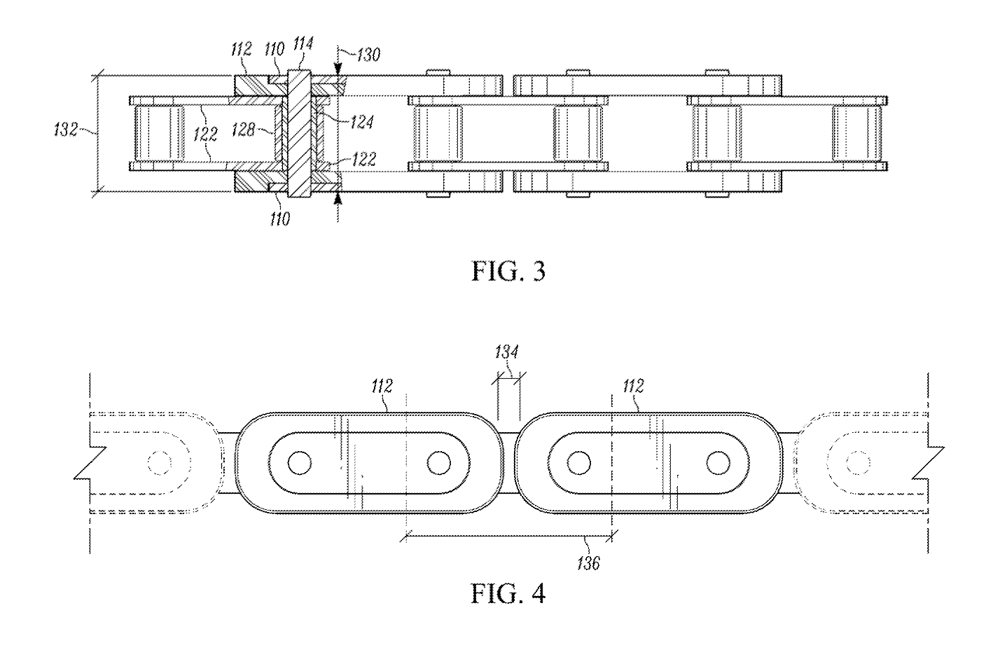

FIG. 3 is a top plan view of the roller chain assembly 100 of FIG. 1, with a portion partially cross-sectioned to illustrate alignment of parts. In one embodiment, a metallic plate width 130 is defined between opposing metallic plate components 110 and is no greater than a plastic plate width 132 defined between opposing plastic plate components 112. This configuration is particularly advantageous in a retro-fit situation, in which a worn-out attachment chain is replaced with the non-marking roller chain of the present disclosure. Preferably, each plastic plate component 112 is partially disposed between the metallic plate component 110 and the roller link plate 122. This configuration provides additional support for the plastic plate component 112 to resist the lateral, side loads imparted from boards moved between conveyors.

FIG. 4 is a side elevation view of the roller chain assembly 100 of FIG. 1. In one embodiment, a gap 134 is defined between longitudinally adjacent pairs of plastic plate components 112 such that no more than 5% of a longitudinal length 136 of the roller link plates 122 is uncovered by the adjacent pairs of plastic plate components 112. This configuration is advantageous because the lumber and boards are nearly fully supported along the length of the chain.

In one embodiment, the roller chain assembly 100 may be configured for direct replacement of an existing chain assembly (not shown) having an existing width. The roller chain assembly is as substantially disclosed above and will not be repeated for the sake of brevity, except as follows. Each composite pin link plate 108 may include a standard metallic plate component 110, which is a conventionally available pin link side plate or bar, such that a new part is not required to implement what is disclosed herein. In this embodiment, a pin link width (which is equivalent to the plastic plate component width) 132 is no greater than the existing width, such that retrofit of the non-marking chain of the present disclosure may be made in a cost-effective and labor-efficient manner.

In another embodiment, an existing chain assembly (not shown) may be reconfigured or retrofitted as a non-marking roller chain of the present disclosure. The existing pin link plates, each comprising a standard metallic plate component, may be removed from the existing chain assembly. Then, each metallic plate component may be fixedly connected to a pocket 118 of a plastic plate component 112, by a press fit, interference fit, friction fit, etc., or the like to create a composite pin link plate 108. The composite pin link plates 108 may then be reattached to the chain assembly, which will now function as a non-marking roller chain using the existing sprockets and associated machinery. Accordingly, with minimal additional parts, cost and labor, an existing assembly may be repaired or upgraded to a non-marking assembly.

In an embodiment, a chain assembly is sized to replace existing chain assemblies of a standard size. As is known in the art, chain assembly may be designed in accordance with a standard, such as one produced by the American National Standards Institute (ANSI). For example, a standard pitch may be required between links in a chain assembly in order for the chain assembly to function properly with sprockets of a standard size. This pitch may be defined as the distance between the center of adjacent rollers 128. Similarly, the diameter of the rollers 128, the width of the roller plate 122, the width of the plates in the pin links 106, and/or the pin link width 132 may be designed in accordance with such a standard. For example, in an embodiment, the metallic plate components 110 and roller links 104 may be of standard size. The pocket 118 of the plastic plate component 112 may be sized to accommodate a metallic plate component 110 of standard size. The plastic plate component 112 may be sized such that no more than 5% of the longitudinal length 136 of each roller link plate 122 is uncovered by the adjacent pairs of plastic plate components 112.

In an embodiment, a chain assembly may be sized so as to replace an existing ANSI 81X chain assembly or to be used with existing machinery sized to accommodate such a chain assembly. For example, the pitch may be approximately 2.6 inches. The pin link width 132 of the chain assembly may be approximately 2.2 inches. Each plastic plate component 112 may have a height of approximately 1 and ⅞ inches, a longitudinal length of approximately 5 inches and a thickness of approximately ⅜ of an inch. The interior and exterior edges of each plastic plate component 112 may be rounded or beveled. This may reduce the likelihood that an object, such as a board, will be scratched or damaged through contact with the plastic plate component. Each metallic plate component 110 may have a height of approximately 1.2 inches, a longitudinal length of approximately 3¾ inches, and a thickness of approximately 0.16 inches. Thus, a gap 134 of less than 0.2 inches exists between adjacent plastic plate components 112, leaving less than 0.2 inches of the lateral surface 136 of each roller link plate 122 exposed. If a roller link plate with a lateral length of approximately 3¾ inches is used, less than 5% of the lateral surface of the roller link plate 122 is exposed.

In an embodiment, a different pitch is used for roller links 104 than for pin links 106. In other words, the distance between rollers in each roller link 104 may differ from the distance between rollers for each pin link 106. In an embodiment, the pitch of each roller link 104 may be greater than the pitch of each pin link 106. In an embodiment, this difference is less than two-hundredths of an inch. This difference may allow a roller chain to function with standard sized sprockets while reducing the uncovered longitudinal length of each roller link 104. In an embodiment, the corners of each roller link plate 122 and each composite pin link plate 108 are rounded. This may permit, for example, the chain assembly to bend without adjacent pin links and/or adjacent roller links contacting one another. In an embodiment, the spaced pin links 114 may extend further in a lateral direction than the metallic plate width 136. In an embodiment, each metallic plate component 110 is recessed within a respective plastic plate component 112 such that the sides of the spaced pin links 114 are substantially flush with the exterior surfaces of the plastic plate components 112. In another embodiment, the exterior surface of each plastic plate component 112 is substantially flush with the exterior surface of a respective metallic plate component 110.

The preceding detailed description merely provides some examples and embodiments of the present disclosure and that numerous changes to the disclosed embodiments may be made in accordance with the disclosure herein without departing from its spirit or scope. The preceding description, therefore, is not meant to limit the scope of the disclosure but to provide sufficient disclosure to one of ordinary skill in the art to practice the invention without undue burden.

What is claimed is:

1. A roller chain assembly comprising:
a series of alternately interconnected roller links and pin links;
each pin link including a pair of composite pin link plates, each composite pin link plate including a metallic plate component and a plastic plate component, wherein for each composite pin link plate the metallic plate component is press fit on a pair of spaced metallic pin members, the plastic plate component is precisely trapped adjacent to the metallic plate component and includes a pocket formed therein, and the pocket is configured to complementarily receive the metallic plate component; and
each roller link including a pair of roller link plates press fit on a pair of bushings and a pair of free-rotating rollers disposed to turn on one of said pair of bushings;
wherein said roller links and said pin links are each adapted to receive a sprocket tooth.

2. The roller chain assembly of claim 1, wherein for each pin link, a metallic plate width defined between the metallic plate components is no greater than a plastic plate width defined between the plastic plate components.

3. The roller chain assembly of claim 1, wherein a gap is defined between adjacent pairs of plastic plate components such that no more than 5% of a longitudinal length of each of the roller link plates is uncovered by the adjacent pairs of plastic plate components.

4. The roller chain assembly of claim 1, wherein for each of the composite pin link plates, at least a portion of the plastic plate component is precisely trapped between the metallic plate component and one of the roller link plates.

5. The roller chain assembly of claim 1, wherein for each of the composite pin link plates, the metallic plate component includes opposing parallel sides that are press fit with complementary side walls formed on the pocket and the plastic component extends beyond the periphery of the metallic plate component.

6. The roller chain assembly of claim 1, wherein each of the pairs of spaced metallic pin members, the pairs of bushings, and the pairs of free-rotating rollers is adapted to receive the sprocket tooth therebetween.

7. A pin link adapted for interconnection with a roller link to form a roller chain assembly, the pin link comprising:
a pair of composite pin link plates, each of the composite pin link plates including a metallic plate component and a plastic plate component, the metallic plate components fixedly mounted on a pair of spaced metallic pin members and including a pair of apertures for receiving the spaced pin members, the plastic plate component fixedly connected to the metallic plate component and including a pocket formed therein, wherein the pocket is configured to complementarily receive the metallic plate component and includes a pair of apertures for receiving the spaced pin members; and wherein said pin link is adapted to receive a sprocket tooth.

8. The pin link of claim 7, wherein a metallic plate width defined between opposing metallic plate components is no greater than a plastic plate width defined between opposing plastic plate components.

9. The pin link of claim 7, wherein the pin link is adapted such that when the roller chain assembly is formed, a gap is defined between adjacent pairs of plastic plate components in the roller chain assembly such that no more than 5% of a longitudinal length of each of the roller links is uncovered by the adjacent pairs of plastic plate components.

10. The pin link of claim 7, wherein when the roller chain assembly is formed, for each composite plate the plastic plate component is partially disposed between the metallic plate component and the roller link.

11. The pin link of claim 7, wherein for each composite plate, the metallic plate component includes opposing parallel sides that are fixedly connected by press fit with complementary side walls of the pocket.

12. A roller chain assembly for direct replacement of an existing chain assembly having an existing width, the roller chain assembly comprising:
a series of alternately interconnected roller links and pin links;
each pin link including a pair of composite pin link plates, each composite pin link plate including a metallic plate component and a plastic plate component, the metallic plate component fixedly mounted on a pair of spaced metallic pin members and including a pair of apertures for receiving the spaced pin members, the plastic plate component fixedly connected to the metallic plate component and including a pocket formed therein, wherein the pocket is configured to complementarily receive the metallic plate component and includes a pair of apertures for receiving the spaced pin members;
each roller link including a pair of roller link plates fixedly mounted on a pair of bushings disposed to turn on said spaced pin members of said pin links, each roller link plate including a pair of apertures for receiving the bushings;
each of said roller links and said pin links adapted to receive a sprocket tooth; wherein for each pin link, a pin link width defined between the pair of composite plates is no greater than the existing width.

13. The roller chain assembly of claim 12, wherein a metallic plate width defined between opposing metallic plate components is no greater than a plastic plate width defined between opposing plastic plate components.

14. The roller chain assembly of claim 12, wherein a gap is defined between adjacent pairs of plastic plate components such that no more than 5% of a longitudinal length of the roller link plates is uncovered by the adjacent pairs of plastic plate components.

15. The roller chain assembly of claim 12, wherein each plastic plate component is partially disposed between the pin link plate and the roller link plate.

16. The roller chain assembly of claim 12, wherein the metallic plate component includes opposing parallel sides that are fixedly connected by press fit with complementary side walls of the pocket.

17. The roller chain assembly of claim 12, wherein the existing chain assembly comprises standard metallic plates and the metallic plate components are identically sized to the standard metallic plates.

18. The roller chain assembly of claim 17, wherein the existing chain assembly comprises standard roller links and the roller links are identically sized to the standard roller links.
